(19) United States
(12) Patent Application Publication
(10) Pub. No.: US 2022/0163731 A1
(43) Pub. Date: May 26, 2022

(54) MULTIPORTS AND OTHER DEVICES HAVING CONNECTION PORT INSERTS AND METHODS OF MAKING THE SAME

(71) Applicant: Corning Research & Development Corporation, Corning, NY (US)

(72) Inventors: Monique Lise Cote, Fort Worth, TX (US); Joel Christopher Rosson, Hickory, NC (US); Pritam Navinchandra Shah, Fort Worth, TX (US); Todd Anthony Tatro, Leander, TX (US)

(21) Appl. No.: 17/102,730

(22) Filed: Nov. 24, 2020

(51) Int. Cl. G02B 6/38

(52) U.S. Cl. CPC G02B 6/3816; G02B 6/3893; G02B 6/3854; G02B 6/3831

(57) ABSTRACT

A multiport assembly including one or more optical adapters configured to receive an optical connector, a shell having a front face defining one or more connection port insert openings extending from an outer surface of the front face into a cavity of the shell, a connection port insert positioned at least partially within the one of the connection port insert openings of the shell, the connection port insert defining a body including an optical connector opening extending from a front end of the body to a rear end of the body, and a sealing member disposed between the connection port insert and the shell.

### TECHNICAL FIELD

The disclosure is directed to devices providing one or more optical connection port openings along with methods for making the same. More specifically, the disclosure is directed to devices such as multiports including a connection port insert positioned within the optical connection port opening for securing an external optical connector along with methods of making the same.

### BACKGROUND

Optical fibers are used in an increasing number and variety of applications, such as a wide variety of telecommunications and data transmission applications. As a result, fiber optic networks include an ever increasing number of terminated optical fibers and fiber optic cables that can be conveniently and reliable mated with corresponding indoor optical connectors within a multiport. These terminated optical fibers and fiber optic cables are available in a variety of connectorized formats including, for example, hardened OptiTap® and OptiTip® connectors, field-installable UniCam® connectors, preconnectorized single or multi-fiber cable assemblies with SC, FC, or LC connectors, etc., all of which are available from Corning Incorporated, with similar products available from other manufacturers.

### SUMMARY

Multiports include a shell having an input port and one or more connection ports for receiving and retaining an external fiber optic connector. Consequently, there is a continuing drive to reduce the cost of material used in forming the multiport, while preserving quick, reliable, and trouble-free optical connection of the external fiber optic connectors to the multiport.

In one embodiment, a multiport assembly includes one or more optical adapters configured to receive an optical connector, a shell having a front face defining one or more connection port insert openings extending from an outer surface of the front face into a cavity of the shell, a connection port insert permanently positioned at least partially within the one of the connection port insert openings of the shell, the connection port insert defining a body comprising an optical connector opening extending from a front end of the body to a rear end of the body, and a sealing member disposed between the connection port insert and the shell.

In another embodiment, a connection port insert assembly positionable within a connection port insert opening of a shell of a multiport includes a connection port insert defining an optical connector opening configured to receive an external fiber optic connector, a locating feature formed in the connection port insert, and a sealing member received within the locating feature.

In yet another embodiment, a method of forming a multiport for receiving one or more optical connectors includes forming one or more connection port inserts, the one or more connection port inserts defining an optical connector opening configured to receive an external fiber optic connector, positioning the one or more connection port inserts within a mold, positioning a sealing member about the one or more connection port inserts, and molding a shell around the one or more connection port inserts to compress the sealing member between the shell and the at least connection port insert and permanently affix the one or more connection port inserts within the shell.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a multiport, according to one or more embodiments shown and described herein;

FIG. 2 schematically depicts an exploded view of the multiport of FIG. 1, according to one or more embodiments shown and described herein;

FIG. 3 schematically depicts a partial perspective view of the multiport of FIG. 1 including a plurality of connection port inserts, according to one or more embodiments shown and described herein;

FIG. 4 schematically depicts a rear perspective view of a connection port insert in isolation, according to one or more embodiments shown and described herein;

FIG. 5, schematically depicts a front perspective view of the connection port insert of FIG. 4, according to one or more embodiments shown and described herein;

FIG. 6 schematically depicts a top plan view of a plurality of linearly arranged connection port insert assemblies each including the connection port insert of FIG. 4 and a sealing member, according to one or more embodiments shown and described herein;

FIG. 7 schematically depicts a cross-section view of a shell of the multiport of FIG. 1, according to one or more embodiments shown and described herein;

FIG. 8 schematically depicts another connection port insert, according to one or more embodiments shown and described herein;

FIG. 9 schematically depicts another sealing member, according to one or more embodiments shown and described herein; and

FIG. 10 schematically depicts a plurality of linearly arranged connection port insert assemblies each including the connection port insert of FIG. 8 and the sealing member of FIG. 9, according to one or more embodiments shown and described herein.

### DETAILED DESCRIPTION

Reference will now be made in detail to the embodiments of the disclosure, examples of which are illustrated in the accompanying drawings. Whenever possible, like reference numbers will be used to refer to like components or parts.

The concepts for the devices disclosed herein are suitable for providing one or more optical connections to the device for indoor, outdoor, or other environments as desired. Generally speaking, the devices disclosed and explained in the exemplary embodiments are multiports, but the concepts disclosed may be used with any suitable device as appropriate. The use of connection port inserts allows a modular construction that may be changed for specific connector types that may be required by a network operator or other users without the time or expense of having to produce new molds for manufacturing.

The concepts disclosed advantageously allow compact form-factors for devices such as multiports including one or more connection ports. The concepts are scalable to any suitable count of connection ports on a device in a variety of arrangements or constructions. The concepts disclosed herein are suitable for optical distribution networks such as for Fiber-to-the-Home and 5G applications, but are equally applicable to other optical applications as well including indoor, automotive, industrial, wireless, or other suitable applications. Additionally, the concepts disclosed may be used with any suitable fiber optic connector footprint of the multiport. Various designs, constructions, or features for devices are disclosed in more detail as discussed herein and may be modified or varied as desired.

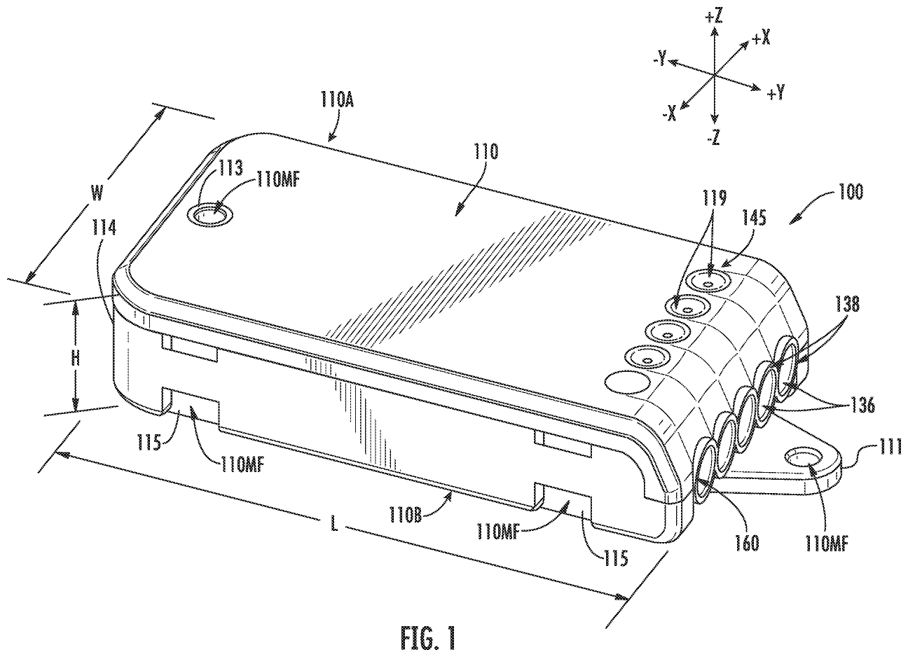

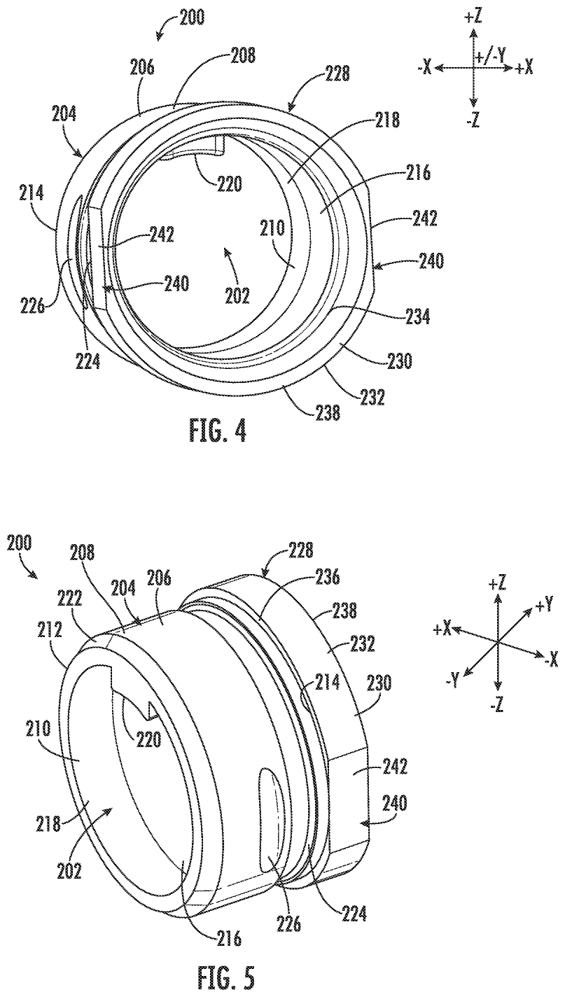

The concepts are shown and described with a multiport 100 having four connection ports that are optically connected to an input port arranged in an array on one end of the multiport 100, but other configuration are possible such as connection ports or input ports on both ends, an express port, a pass-through port, or the like. FIGS. 1-3 show the construction and features for the multiport 100 and FIGS. 4-10 show explanatory connection port inserts.

Referring now to FIGS. 1-3, an explanatory multiport 100 is illustrated. The shell 110 is formed by an upper portion 110A and a lower portion 110B, but other constructions are possible for the shell 110 using the concept disclosed. While the upper portion 110A and the lower portion 110B are described as being “upper” and “lower,” it should be understood that this is merely exemplary, and the upper portion 110A need not be positioned above the lower portion 110B in a vertical direction.

The concepts disclosed allow relatively small multiports 100 having a relatively high-density of connections along with an organized arrangement for connectors attached to the multiport 100. The shell 110 has a given height H, a width W, and a length L that define a volume for the multiport 100. By way of example, the shell 110 of multiport 100 may define a volume of about 800 cubic centimeters or less, about 400 cubic centimeters or less, about 100 cubic centimeters or less as desired.

In embodiments, the upper portion 110A includes one or more of securing feature passageways 145 for receiving one or more securing features 119 positionable therein. In embodiments, the lower portion 110B of the shell 110 includes a front face 112 having an outer surface 134. For example, in some embodiments, the front face 112 of the lower portion 110B is monolithic.

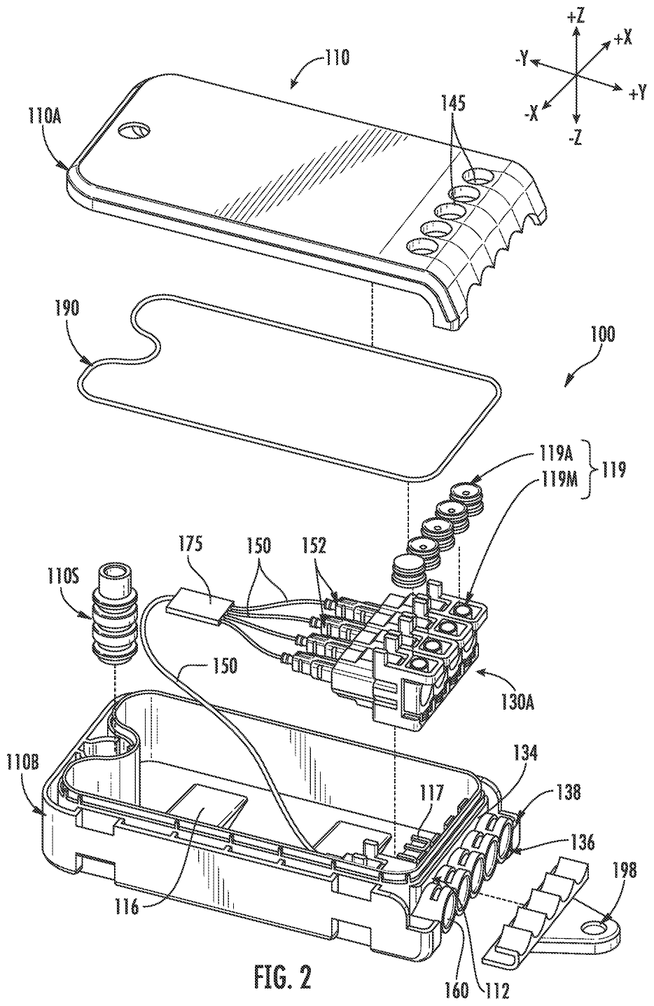

The multiport 100, in some embodiments, may include mounting features that are integrally formed in the shell 110 or that are separate components attached to the shell 110 for mounting the multiport 100. By way of example and as shown in FIG. 1, in some embodiments, the shell 110 may include mounting features 110MF positioned on a side face of the shell 110 between the front face 112 (FIG. 2) and an opposite rear face 114 of the shell 110. The mounting feature 110MF adjacent the front face 112 of multiport 100 is a mounting tab 111 attached to the shell 110, and the mounting feature 110MF adjacent the rear face 114 and formed in the upper shell portion 110A of the shell 110 is a through hole 113 with a support 1105, as shown in FIG. 2. However, the mounting features 110MF may be positioned at any suitable location on the shell 110. For instance, the multiport 100 may include a plurality of mounting features 110MF integrally-formed on the shell 110 and configured as passageways 115 positioned on lateral sides thereof. Thus, the user may simply use a fastener such as a zip-tie threaded through these lateral passageways 115 for mounting the multiport 100 to a wall or pole as desired.

The multiport 100 disclosed herein may be weatherproof by appropriately sealing seams of the shell 110. For example, in some embodiments, the shell 110 may include gaskets, O-rings, adhesive, sealant, welding, overmolding, or the like that may resist the passage of environmental elements (e.g., water, moisture, and the like). To this end, the multiport 100 may include a sealing element 190 positioned between the upper shell portion 110A and the lower shell portion 110B of the shell 110. The sealing element 190 may cooperate with the shell 110 geometry, such as with respective grooves or tongues in the shell 110. For example, in some embodiments, grooves or tongues may extend about the perimeter of the shell 110 between the upper shell portion 110A and the lower shell portion 110B. By way of explanation, grooves may receive one or more appropriately sized O-rings or gaskets for weatherproofing the multiport 100, but an adhesive or other material may be used in the groove. By way of example, the O-rings are suitably sized for creating a seal between the upper shell portion 110A and the lower shell portion 110B. By way of example, suitable O-rings may be a compression O-ring for maintaining a weatherproof seal. Other embodiments may use an adhesive or suitable welding of the materials for sealing the upper shell portion 110A to the lower shell portion 110B. If the multiport 100 is intended for indoor applications, the weatherproofing may not be required.

In embodiments, the multiport 100 may include an input port 160 and one or more connection ports 136. As discussed in more detail herein, the connection ports 136 and/or the input port 160 are configured to receive suitable external fiber optic connectors for making optical connections with the multiport 100. In some embodiments, the input port 160 and the one or more connection ports 136 are formed in the front face 112. Specifically, the one or more connection ports 136 and the input port 160 extend from the outer surface 134 of the front face 112 of the multiport 100 into a cavity 116 of the multiport 100. While in the embodiment depicted in FIG. 2, the input port 160 is positioned on the front face 112, it should be understood that this is merely an example, and the input port 160 may be positioned at any suitable location on the multiport 100.

As shown herein, a plurality of connection ports 136 are illustrated. The connection ports 136 and the input port 160 each define a respective connection port insert opening 138 extending from the outer surface 134 of the front face 112 of the multiport 100 into the cavity 116 of the multiport 100. In embodiments, the connection ports 136 and/or the input port 160 may include a marking or indicia such as an embossed number or text for distinguishing between each of the connection ports 136 and the input port 160, but other markings or indicia are also possible.

In embodiments, the lower shell portion 110B of the shell 110, including the front face 112, the connection ports 136 and the input port 160, is a monolithic structure fabricated from a first material. In embodiments, the first material has a Young's modulus of about 3.0 gigapascals (GPa) or less, about 2.5 GPa or less, from about 1.0 to about 2.5 GPa, inclusive of the endpoints, or from about 1.5 to about 2.0 GPa, inclusive of the endpoints. In embodiments, the first material may have a melting temperature of about 350° Celsius (C) or less, about 300° C. or less, about 250° C. or less, from about 100° C. to about 300° C., inclusive of the endpoints, or from about 150° C. to about 250° C., inclusive of the endpoints. In embodiments, the first material may be a polymer, such as polypropylene, polycarbonate, or polyethylene, or a combination thereof.

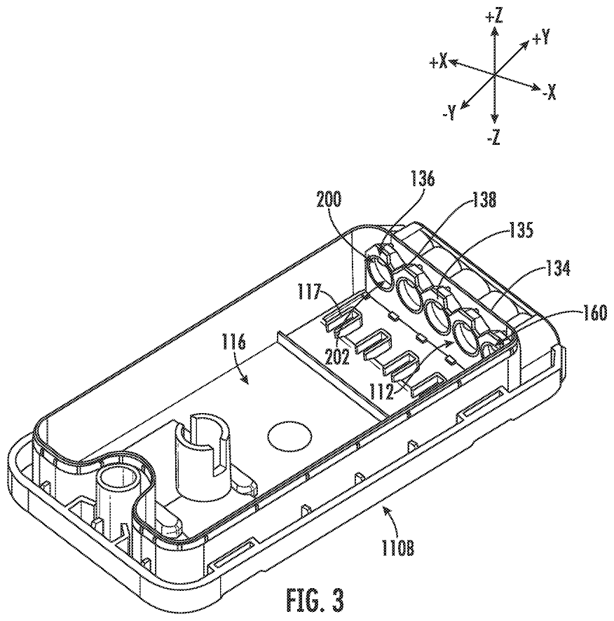

As shown in FIG. 3, a connection port insert 200 is positioned within one or more of the connection port insert openings 138 defined by the connection ports 136 and the input port 160. As described in more detail herein, in some embodiments, the connection port inserts 200 are initially formed and positioned within a mold. The shell 110, or at least the lower shell portion 110B of the shell 110, may then be molded around the connection port inserts 200, such that the connection port inserts 200 are captured within the connection port insert openings 138 of the connection ports 136 and the input port 160. By molding the shell 110 around the connection port inserts 200, the connection port inserts 200 become permanently affixed within the shell 110. As used herein, “permanently affixed” means the connection port insert 200 is not removable from the shell 110, and attempting to remove the same would cause damage to the shell 110 and/or the connection port insert 200. Thus, molding the shell 110 around the connection port inserts 200 encapsulates a portion of the connection port insert 200 therein such that it is irremovable without causing damage. In embodiments, an outer surface of the connection port inserts 200 may be fused to the shell 110 as a result of molding the shell 110 around the connection port inserts 200.

Each connection port insert 200, in embodiments, defines an optical connector opening 202. Optical connections to the multiport 100 are made by inserting one or more suitable external fiber optic connectors into an optical connector opening 202 of a respective connection port insert 200 as desired. Specifically, the connection port inserts 200 are configured to receive a suitable external fiber optic connector (hereinafter “connector”) of a fiber optic cable assembly (hereinafter “cable assembly”).

Referring again to FIG. 2, an exploded view of a multiport assembly including the multiport 100 illustrates optical fibers 150 that optically couple rear connectors 152 that are in communication the connection ports 136 and the input port 160 inside the multiport 100 via an adapter 130A. In embodiments, the rear connectors 152 are optically coupled to the optical fibers 150. The optical fibers 150 may be routed through an optical splitter 175 that is structurally configured to split a signal received from the rear connector 152 of the input port 160. As shown, the adapters 130A are positioned in the lower shell portion 110B of the shell 110. As shown, the multiport 100 includes a plurality of adapters 130A for receiving respective rear connectors 152 in alignment with a respective connection port 136 for making the optical connection with the external connector.

The adapters 130A are suitable for securing a respective rear connector 152 thereto and aligning the rear connectors 152 with a respective connection port 136. One or more optical fibers 150 may be routed from the connection port 136 toward an input port 160 of the multiport 100. For instance, the rear connector 152 may terminate the optical fiber 150 for optical connection at connection port 136 and route the optical fiber 150 for optical communication with the input port 160.

More particularly, the input port 160 receives one or more optical fibers and then routes the optical signals as desired such as passing the signal through 1:1 distribution, routing through the optical splitter 175 or passing optical fibers through the multiport 100. The splitter 175 allows a single optical signal to be split into multiple signals such as 1×N split, but other splitter arrangements are possible such as a 2×N split. For instance, a single optical fiber may feed the input port 160 and use a 1×8 splitter within the multiport 100 to allow eight connection ports 136 for outputs on the multiport 100. The input port 160 may be configured in a suitable manner as appropriate such as a single-fiber or multi-fiber port. Likewise, the connection ports 136 may be configured as a single-fiber port or multi-fiber port.

The rear connectors 152 are shown aligned with respective connection ports 136 within the cavity 116 of the multiport 100. The rear connectors 152, in embodiments, are associated with one or more of the plurality of optical fibers 150. Each of the respective rear connectors 152 aligns and attaches to a structure such as the adapter 130A or other structure related to the connection ports 136 in any suitable matter. The plurality of rear connectors 152 may include a suitable rear connector ferrule, as desired and the rear connectors 152 may take any suitable form from a simple ferrule that attaches to a standard connector type inserted into an adapter. By way of example, the rear connectors 152 may include a resilient member for biasing the rear connector ferrule or not.

Referring still to FIG. 2, in some embodiments, the rear connectors 152 may have a SC footprint, but other connectors are possible. Additionally, the lower shell portion 110B of the shell 110 includes a retention feature 117, as shown in FIGS. 2 and 3, for seating the adapters 130A in the multiport 100 adjacent to the connection ports 136.

The rear connectors 152 may take any suitable form and be aligned for mating with the connector secured within each connection port 136 in any suitable manner. For example, in some embodiments, the adapters 130A may include latch arms for securing respective rear connectors 152 therein.

As shown in FIG. 2, the multiport 100 includes a single input optical fiber of the input port 160 routed to a 1:4 splitter 175 and then each one of the individual optical fibers 150 from the splitter 175 is routed to each of the respective rear connector 152 of the four connection ports 136. The input port 160 may be configured in any suitable configuration for the multiport 100 disclosed as desired for the given application. For example, input ports 160 according to the present disclosure may be configured to receive a single fiber connector, a multi-fiber input connector, a tether input that may be a stubbed cable or terminated with a connector or even one of the connection ports 136 may function as an pass-through connection port as desired.

In some embodiments, two or more optical fibers 150 may be routed from one or more of the plurality of the connection ports 136 of the multiport 100 disclosed herein. For instance, two optical fibers may be routed from each of the four connection ports 136 of the multiport 100 toward the input port 160 with or without the splitter 175 such as single-fiber input port 160 using a 1:8 splitter or by using an eight-fiber connection at the input port 160 for a 1:1 fiber distribution.

In embodiments, each securing feature 119 includes an actuator 119A and a securing member 119M. A portion of actuator 119A is positioned within a portion of the securing feature passageway 145 and cooperates with the securing member 119M of the respective securing feature 119. Consequently, a portion of securing feature 119 (i.e., the actuator 119A) is capable of translating within a portion of the securing feature passageway 145.

Referring now to FIGS. 4 and 5, the connection port insert 200 is illustrated in isolation. It should be appreciated that connection port inserts 200 are positioned within each of the connection ports 136 (FIG. 3) and the input port 160 (FIG. 3), as discussed herein. In embodiments, the connection port insert 200 includes a body 204 defining a peripheral wall 206 having an outer surface 208, an opposite inner surface 210, a front end 212, and an opposite rear end 214. The inner surface 210 of the body 204 defines the optical connector opening 202 for receiving an optical connector, as discussed above. The inner surface 210 of the body 204 has a precision surface portion 216 for mating with the optical connector. As shown, the precision surface portion 216 of the body 204 has a span. The span may be within +/−50 microns of a nominal span. In some embodiments, precision surface portion 216 has a circular geometry for mating with an optical connector having a corresponding circular outer geometry. As such, the span may be a diameter of the inner surface 210. In embodiments, the precision surface portion 216 has a diameter of 10.45+/−0.03 millimeters (mm). However, it should be appreciated that the geometry of the precision surface portion 216 may be any suitable geometry corresponding to a geometry of an optical connector to be received within the optical connector opening 202 of the connection port insert 200. For example, while in the embodiment depicted in FIGS. 4 and 5 the precision surface portion 216 has a circular shape, the precision surface portion 216 may include a rectangular shape, a square shape, a polygonal shape, or the like.

In some embodiments, the inner surface 210 of the body 204 has a front inner surface portion 218 between the precision surface portion 216 and the front end 212 of the body 204. The front inner surface portion 218 extends radially outwardly from the precision surface portion 216 toward the front end 212 of the body 204.

In embodiments, the body 204 defines a keying portion 220 extending radially inwardly from the inner surface 210 of the body 204. Specifically, as shown, the keying portion 220 may extend radially inwardly from the front inner surface portion 218 of the body 204 at the front end 212 thereof. The keying portion 220 cooperates with a key on a complimentary external fiber optic connector to inhibit damage to the connection port insert 200 by inhibiting the insertion of a non-compliant connector. The keying portion 220 may aid the user during blind insertion of the connector into the connection port insert 200 to determine the correct rotational orientation with respect to the connection port insert 200. It should be understood that, in embodiments, the keying portion 220 may define a slot or recess extending radially outwardly from the inner surface 210 of the body 204. As such, the keying portion 220 in this embodiment cooperates with a key on a complimentary external fiber optic connector extending radially outwardly.

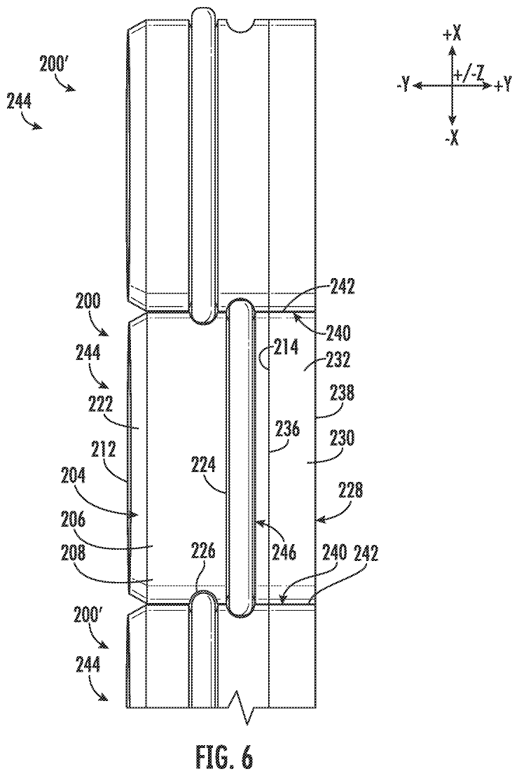

In embodiments, the outer surface 208 of the body 204 has a front outer surface portion 222 extending radially outwardly from the front end 212 of the body 204. The body 204 may define a locating feature 224 for retaining a sealing member in position on the body 204. The locating feature 224 may be a groove extending radially inwardly from the outer surface 208 of the body 204, a step formed in the outer surface 208 of the body 204, a protrusion, and the like for retaining a sealing member in position. As shown in FIG. 5, the locating feature 224 is a groove and, in some embodiments, extends along an entire circumference of the outer surface 208 of the body 204 and is configured to receive a sealing member, such as an O-ring, a gasket, or the like. In embodiments, the body 204 defines a rotationally-discrete locating feature segment 226 extending inwardly from the outer surface 208 of the body 204 configured to receive a portion of a sealing member surrounding an adjacent connection port insert 200. The locating feature segment 226 may be a groove segment, a step formed in the body 204, a protrusion, and the like for receiving or retaining a sealing member of an adjacent connection port insert 200 in position. As shown in FIG. 5 and contrary to the locating feature 224 formed in the body 204, the locating feature segment 226 is a groove segment that extends only partially around the circumference of the body 204 to receive a portion of a sealing member of an adjacent connection port insert 200, as described in more detail herein. Although only one locating feature segment 226 is shown in the view shown in FIG. 5, it should be appreciated that the body 204 may define multiple locating feature segments 226 about the body 204. As shown, the locating feature 224 is formed in the body 204 between the rear end 214 of the body 204 and the locating feature segment 226. In some embodiments, the locating feature 224 may be formed on a side of the locating feature segment 226 opposite the rear end 214 of the body 204, such as between the locating feature segment 226 and the front end 212 of the body 204, as shown in connection port insert 200′ illustrated in FIG. 6.

The connection port insert 200 may include a flange 228 defining a peripheral wall 230 having an outer surface 232, an opposite inner surface 234, a front end 236, and an opposite rear end 238. The inner surface 234 of the flange 228 may be continuous with the inner surface 210 of the body 204. As such, the front end 236 of the flange 228 extends from the rear end 238 of the body 204. The inner surface 234 of the flange 228 may extend radially outwardly from the front end 236 of the flange 228 toward the rear end 238 of the flange 228. Similar to the body 204, the inner surface 234 of the flange 228 may have a circular geometry corresponding to the geometry of the inner surface 210 of the body 204. However, the geometry of the inner surface 234 of the flange 228 is not limited to that illustrated herein. Further, the outer surface 232 of the flange 228 has a span. The span may have a substantially circular geometry. In embodiments, the span has a diameter greater than a diameter of the outer surface 208 of the body 204.

Referring still to FIGS. 4 and 5, in embodiments, the flange 228 of the connection port insert 200 may include a clearance feature 240 defined on the outer surface 232 of the flange 228. In embodiments, the clearance feature 240 faces a corresponding clearance feature 240 of an adjacent connection port insert 200 to reduce the length of an array of connection port inserts 200 extending in a width direction. It should be appreciated that a pair of adjacent connection port inserts 200 may be spaced apart from one another to provide a space or gap between the clearance features 240. In embodiments, the clearance feature 240 is configured to receive or mate with a corresponding clearance feature 240 of an adjacent connection port insert 200 such that the connection port inserts 200 may create a flush mating surface between the clearance features 240 when positioned in a linear configuration extending in a lateral direction with respect to one another. As shown, the flange 228 of the connection port insert 200 has a pair of clearance features 240 on opposite sides of the flange 228. In some embodiments, each clearance feature 240 is aligned with a corresponding locating feature segment 226 in a longitudinal direction. As a non-limiting example, as shown, the clearance feature 240 of the flange 228 is a planar wall portion 242 formed in a side of the outer surface 232 of the flange 228. In some embodiments, the planar wall portions 242 on each side of the flange 228 are parallel to one another. However, it should be appreciated that the clearance feature 240 of the flange 228 may have any suitable geometry to match a corresponding clearance feature 240 of an adjacent connection port insert 200. As a non-limiting example, the clearance feature 240 of the connection port insert 200 may be a concave wall portion formed on the side of the outer surface 232 of the flange 228 configured to mate with a clearance feature 240 of an adjacent connection port insert 200 that is a convex wall portion. Further, a clearance feature 240 on one side of the connection port insert 200 may be a concave wall portion and a clearance feature 240 on an opposite side of the connection port insert 200 may be a convex wall portion. As such, clearance features 240 may have other suitable geometries configured to accommodate a clearance feature 240 of an adjacent connection port insert 200 such that the bodies 204 can be engaged with one another and reduce the size of the multiport 100.

The body 204 and the flange 228 of the connection port insert 200 may form a monolithic structure. In embodiments, the connection port insert 200 is fabricated from a second material different from the first material forming the lower shell portion 110B of the shell 110. The second material, in embodiments, may have a hardness value greater than a hardness value of the first material. In embodiments, the second material may have a Young's modulus of about 5.0 gigapascals or less, about 4.0 GPa or less, from about 2.0 GPa to about 5.0 GPa, inclusive of the endpoints, from about 1.5 GPa to about 4.5 GPa, inclusive of the endpoints, from about 2.0 GPa to about 4.0 GPa, inclusive of the endpoints, or from about 2.5 GPa to about 3.5 GPa, inclusive of the endpoints. In some embodiments, the second material has a melting point that is greater than a melting point of the first material. In embodiments, the first material has a melting temperature of about 800° C. or less, about 700° C. or less, about 600° C. or less, from about 500° C. to about 800° C., inclusive of the endpoints, or from about 600° C. to about 700° C., inclusive of the endpoints. As a non-limiting example, the second material may be polyetherimide, such as Ultem, or polyetheretherketone.

Referring now to FIG. 6, a top plan view of a plurality of connection port insert assemblies 244 arranged in a lateral direction is illustrated. Each connection port insert assembly 244 includes the connection port insert 200, or connection port insert 200′, as described herein, and a sealing member 246. In embodiments, the sealing member 246 may include an O-ring, a gasket, or the like. Each sealing member 246 is positioned within or against a locating feature 224 formed in the body 204 of each connection port insert 200 such that each sealing member 246 circumscribes a respective connection port insert 200. The sealing member 246 may be fabricated from any suitable elastomer such as, for example, neoprene, rubber, silicone, and the like.

The connection port inserts 200 are arranged such that the clearance feature 240 of one connection port insert 200 mates with the clearance feature 240 of an adjacent connection port insert 200′. As such, the clearance feature 240 is flush with the clearance feature 240 of an adjacent connection port insert 200′. As described herein, the locating feature 224 formed in the body 204 of each connection port insert 200 may be positioned between the locating feature segment 226 and the rear end 214 of the body 204 or, alternatively, between the locating feature segment 226 and the front end 212 of the body 204. Thus, in order to arrange the connection port insert assemblies 244 in a flush manner such that the sealing member 246 of one connection port insert assembly 244 is received within the locating feature segment 226 of an adjacent connection port insert 200′, the connection port insert assemblies 244 are positioned in an alternating arrangement with respect to the position of the locating feature 224 relative to the locating feature segments 226. More specifically, the locating feature 224 formed in the body 204 of each connection port insert 200 is offset or staggered relative to a locating feature 224 formed in the body 204 of an adjacent connection port insert 200′ in a longitudinal direction that is transverse to the lateral direction.

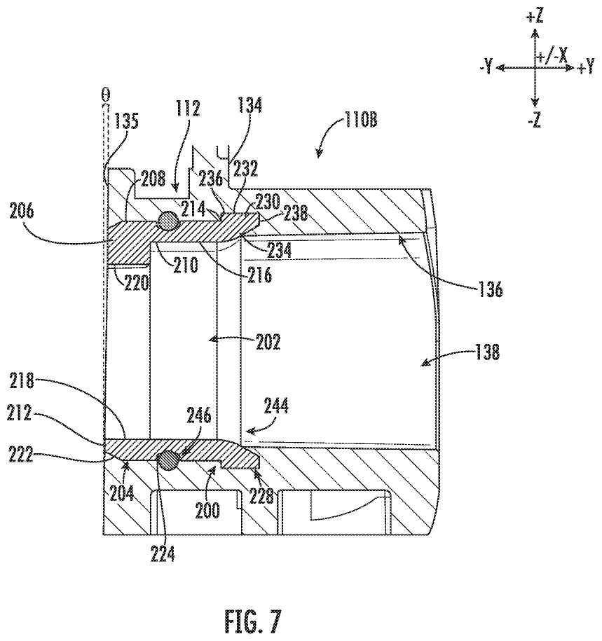

Referring now to FIG. 7, a cross-section side view of the multiport 100 is shown with the connection port insert assembly 244, including the connection port insert 200 and the sealing member 246, molded within a connection port 136 formed in the lower shell portion 110B of the shell 110. Specifically, the lower shell portion 110B of the shell 110 is molded around the connection port insert assembly 244 in any suitable manner. In embodiments, the lower shell portion 110B is injection molded around the connection port insert assembly 244. In embodiments, the lower shell portion 110B overmolded around the connection port insert assembly 244. As such, it should be appreciated that the connection port insert 200, as discussed herein, is initially formed using the second material, the sealing member 246 is positioned within the locating feature 224 of the connection port insert 200, and the connection port insert assembly 244 is positioned within a mold. In embodiments, as noted above, the multiport 100 may include a plurality of connection ports 136 with a connection port insert 200 positioned within each connection port 136. As such, a plurality of connection port inserts 200 may be linearly arranged in a lateral direction within the mold and the shell 110 is then molded, using the first material, around the connection port inserts 200. The shell 110 may be molded by injecting, blow molding, or spin casting the first material into the mold at 10,000 psi to 20,000 psi. Although not illustrated, the sealing member 246 provided within the locating feature 224 formed in the body 204 of the connection port insert 200 is compressed by the lower shell portion 110B of the shell 110 during the molding process by injecting the first material at such a high pressure to create a fluid tight seal. This prevents fluid and debris from entering the multiport 100 between the connection port insert 200 and the lower shell portion 110B of the shell 110.

As shown in FIG. 7, in embodiments, the front end 212 of the body 204 of the connection port insert 200 is drafted to be formed at an angle θ relative to an imaginary line perpendicular to a longitudinal axis extending through the optical connector opening 202. In embodiments, the angle θ is about 1°. Thus, the front end 212 of the body 204 defines a front plane that may be non-parallel to a rear plane defined by the rear end 238 of the flange 228. Similarly, an inner surface 135 of the front face 112 of the lower shell portion 110B of the shell 110 is drafted to be formed at the angle θ corresponding to that of the front end 212 of the body 204. The angle θ of the drafted front end 212 of the body 204 may be the same as the angle θ of the drafted inner surface 135 of the front face 112. As such, in embodiments, the angle θ is about 1°. Thus, the inner surface 135 of the front face 112 may be non-parallel to the outer surface 134 of the front face 112. This reduces the likelihood of the first material forming the lower shell portion 110B of the shell 110 adhering to a molding block positioned within the mold during the molding process. Furthermore, the drafted front end 212 of the body 204 and front face 112 may permit the molding block to be easily removed from the mold after the molding process is completed.

Referring now to FIG. 8, another connection port insert 300 for use in a multiport, such as the multiport 100, is illustrated. It should be appreciated that the connection port insert 300 may be inserted into the connection port insert opening 138 formed in the lower shell portion 110B of the shell 110. Similar to the connection port insert 200 described above and depicted in FIGS. 4-7, the connection port insert 300 defines the body 302 having the inner surface 304, the outer surface 306, the front end 308, and the rear end 310, and the flange 312 having the inner surface, the outer surface 316, the front end 318, and the rear end 320. Additionally, the body 302 of the connection port insert 300 defines the keying portion 322 and the flange 312 defines the one or more clearance features 324 formed in the outer surface 316 of the flange 312. The body 302 defines the locating feature 326 extending radially inwardly from the outer surface 306 of the body 302 and around a circumference thereof. However, the connection port insert 300 does not define the locating feature segments 226 as discussed above with regard to the connection port insert 200.

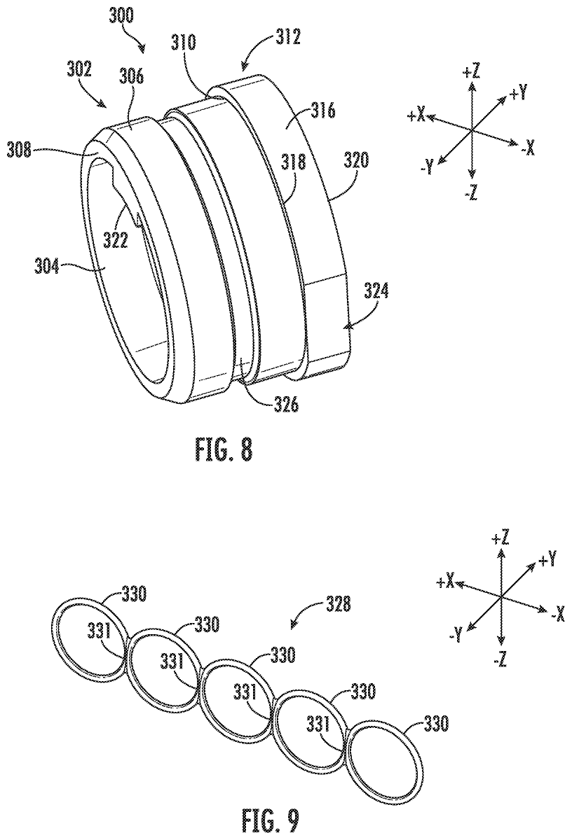

Referring now to FIG. 9, a sealing member 328 is illustrated. The sealing member 328 is a monolithic component and includes an array of bridge members 330. In embodiments, each bridge member 330 is an O-ring. The bridge members 330 are secured at one or more sides thereof at bonded portions 331. The sealing member 328 may be fabricated from any suitable elastomer such as, for example, neoprene, rubber, silicone, and the like. By providing a singular sealing member 328 in which the bridge members 330 are bonded to one another, the need to stagger the locating feature 326 and provide locating feature segments, as defined in the connection port insert 200, is no longer necessary.

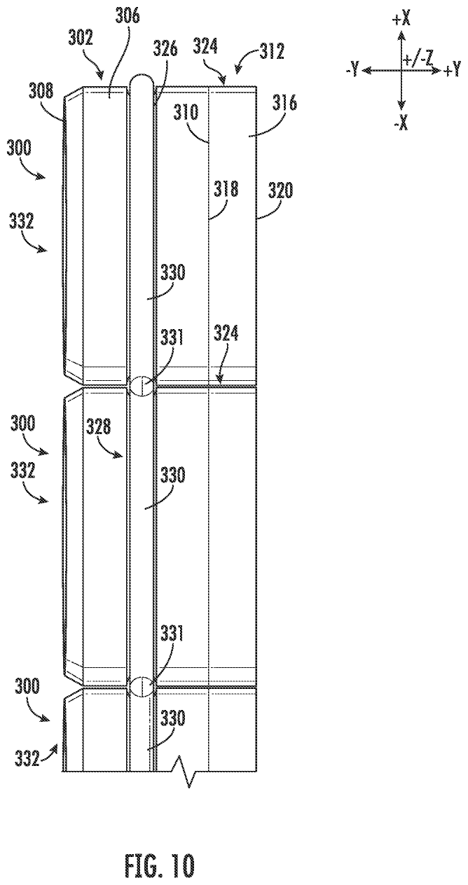

Referring now to FIG. 10, a top plan view of a plurality of connection port insert assemblies 332, including a plurality of connection port inserts 300 and the sealing member 328, is shown arranged in a lateral direction. As shown, each connection port insert 300 includes a portion of the sealing member 328, i.e., an associated bridge member 330, positioned within the locating feature 326 formed in the body 302 of a respective connection port insert 300. Thus, the connection port inserts 300 may still be arranged in a flush manner next to one another without being separated by a thickness of an individual bridge member 330 of the sealing member 328 between adjacent connection port inserts 300, i.e., the bonded portions 331.

From the above, it is to be appreciated that defined herein is a multiport assembly including a shell having a monolithic front face defining one or more connection port insert openings extending from an outer surface of the front face into a cavity of the shell, a connection port insert positioned at least partially within the one or more connection port insert openings of the front face, and a sealing member received within a locating feature formed in the connection port insert. The shell is fabricated from a first material and the connection port insert is fabricated from a second material different from the first material.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A multiport assembly comprising:
one or more optical adapters configured to receive an optical connector;
a shell having a front face defining one or more connection port insert openings extending from an outer surface of the front face into a cavity of the shell;
a connection port insert permanently positioned at least partially within the one of the one or more connection port insert openings of the shell, the connection port insert defining a body comprising an optical connector opening extending from a front end of the body to a rear end of the body; and
a sealing member disposed between the connection port insert and the shell.

2. The multiport assembly of claim 1, wherein the shell comprises a first material and the connection port insert comprises a second material different from the first material.

3. The multiport assembly of claim 2, wherein the first material has a hardness that is less than a hardness of the second material.

4. The multiport assembly of claim 2, wherein the first material has a melting point that is less than a melting point of the second material.

5. The multiport assembly of claim 3, wherein the second material is either polyetherimide or polyetheretherketone.

6. The multiport assembly of claim 3, wherein the first material comprises one or more of polypropylene, polycarbonate, and polyethylene.

7. The multiport assembly of claim 1, wherein the body of the connection port insert is positioned at the cavity of the shell and further comprises a flange disposed at the rear end of the body.

8. The multiport assembly of claim 7, wherein the body of the connection port insert defines a keying portion extending radially inwardly from an inner surface of the body.

9. The multiport assembly of claim 8, wherein the flange defines a clearance feature formed on a side of the outer surface of the flange.

10. The multiport assembly of claim 9, wherein the clearance feature defines a planar wall portion formed on the side of the outer surface of the flange.

11. The multiport assembly of claim 9, wherein a locating feature is formed in the outer surface of the body.

12. The multiport assembly of claim 11, further comprising:
a plurality of connection port insert openings; and
a plurality of connection port inserts, each connection port insert positioned within a corresponding connection port.

13. The multiport assembly of claim 12, wherein the plurality of connection port inserts are arranged along a lateral direction of the shell such that the clearance feature of each connection port insert faces a clearance feature of an adjacent connection port insert.

14. The multiport assembly of claim 13, wherein the locating feature formed in the body of each connection port insert is staggered relative to a locating feature formed in the body of an adjacent connection port insert in a longitudinal direction that is transverse to the lateral direction.

15. The multiport assembly of claim 14, wherein each connection port insert has a rotationally-discrete locating feature segment extending radially inwardly from the outer surface of the body and aligned with the clearance feature in the longitudinal direction for receiving a portion of a sealing member of an adjacent connection port insert.

16. A connection port insert assembly positionable within a connection port insert opening of a shell of a multiport, the connection port insert assembly comprising:
a connection port insert defining an optical connector opening configured to receive an external fiber optic connector, a locating feature formed in the connection port insert; and
a sealing member received within the locating feature.

17. The connection port insert assembly of claim 16, wherein the connection port insert is fabricated from either Ultem or polyetheretherketone.

18. The connection port insert assembly of claim 16, wherein the shell comprises a first material and the connection port insert comprises a second material different from the first material, the first material has a melting point that is less than a melting point of the second material.

19. The connection port insert assembly of claim 16, further comprising:
a body having a front end and a rear end opposite the front end; and
a flange disposed at the rear end of the body.

20. The connection port insert assembly of claim 19, further comprising a keying portion extending radially inwardly from an inner surface of the body.

21. The connection port insert assembly of claim 20, wherein the flange comprises a clearance feature formed on a side of an outer surface of the flange.

22. The connection port insert assembly of claim 21, further comprising a sealing member received within a locating feature extending radially inwardly from the outer surface of the body.

23. The connection port insert assembly of claim 22, further comprising a rotationally-discrete locating feature segment extending radially inwardly from the outer surface of the body and aligned with the clearance feature in a longitudinal direction.

24. The connection port insert assembly of claim 23, wherein a pair of rotationally-discrete locating feature segments is formed on a side of the locating feature opposite the clearance feature.

25. The connection port insert assembly of claim 23, wherein the rotationally-discrete locating feature segment is positioned between the locating feature and the clearance feature.

26. A method of forming a multiport for receiving one or more optical connectors, the method comprising:
providing one or more connection port inserts, the one or more connection port inserts defining an optical connector opening configured to receive an external fiber optic connector;
positioning the one or more connection port inserts within a mold;
positioning a sealing member about the one or more connection port inserts; and
molding a shell around the one or more connection port inserts to compress the sealing member between the shell and the one or more connection port inserts and permanently affix the one or more connection port inserts within the shell.

27. The method of claim 26, further comprising:
the one or more connection port inserts comprising a first material; and
the shell comprising a second material different from the first material.

28. The method of claim 26, wherein the molding of the shell comprises compressing the sealing member at a pressure between 10,000 psi and 20,000 psi.

29. The method of claim 26, wherein the forming the one or more connection port inserts further comprises:
forming a body having a front end and an opposite rear end, the body positioned at a cavity of the shell, a keying portion extending radially inwardly from an inner surface of the body of the one or more connection port inserts; and
forming a flange having a front end and a rear end opposite the front end, the flange positioned at the rear end of the body, the flange comprising a clearance feature formed on a side of an outer surface of the flange.

30. The method of claim 29, further comprising:
forming a plurality of connection port inserts;
positioning the plurality of connection port inserts into the mold; and
molding the shell to form a plurality of connection port insert openings, each connection port insert positioned within a corresponding connection port insert opening.
